(19) United States
(12) Patent Application Publication
(10) Pub. No.: US 2012/0133069 A1
(43) Pub. Date: May 31, 2012

(54) MOLDING METHOD FOR EXPANDABLE POLYPROPYLENE

(75) Inventors: Sidney Kwun Wa Leung, Macau (CN); Eric Tang, Hong Kong (CN)

(73) Assignee: Sidney Kwun Wa Lueng, Macau (CN)

(21) Appl. No.: 13/116,284

(22) Filed: May 26, 2011

(30) Foreign Application Priority Data
Nov. 29, 2010 (CN) 201010568086.X

(51) Int. Cl. B29C 67/20; B29C 51/02

(52) U.S. Cl. 264/46.4

(57) ABSTRACT

The present invention provides a vacuum thermoforming process-combined one-step molding method for expandable polypropylene, comprising the steps of silk screen printing on a plastic sheet, subjecting the plastic sheet to vacuum thermoforming to provide a vacuum thermoforming part, and foaming an expandable polypropylene and integratedly molding the expandable polypropylene with the vacuum thermoforming part. The expandable polypropylene vacuum thermoforming product produced by the method according to the present invention exhibits an improved impact resistance, and the production process is more superior.

### FIELD OF THE INVENTION

The present invention relates to a molding method for expandable polypropylene. Particularly, the present invention relates to a vacuum thermoforming process-combined one-step molding method for expandable polypropylene.

### BACKGROUND OF THE INVENTION

Currently, foamed plastics have been widely applied in the fields of commodities, traffics, industrial productions, aeronautics and the like due to their superior properties such as low density, high specific strength, strong energy absorption ability and good performance in sound insulation and thermal insulation, etc.

In the manufacture of helmets such as those for bicycle, skiing/skating, ice hockey, mountain climbing, horse riding, aquatics, industrial uses, and the like, since there is a strict requirement for the strength of the final products, a vacuum thermoforming process is normally required for the expandable polypropylene plastic used in above products to further increase their strength.

Currently, a secondary molding method is adopted for combination of an expandable polypropylene with the vacuum thermoforming process, which involves vacuum forming a thermoforming part having a specific shape by using a vacuum thermoforming mold, and then subjecting said thermoforming part to punching and trimming so as to finish the specific shape. EPP beads are then subjected to injection foam molding (first molding) to obtain an EPP foam part, followed by integrated molding (second molding) of the EPP foam part with the vacuum thermoforming part. However, the production procedures of said method are complex, and the production period is long. Moreover, vacuum thermoforming and combination strength are insufficient, which adversely affects the production period and the product strength.

### SUMMARY OF THE INVENTION

In view of above problems in the prior art, an objective of the present invention is to provide a molding method for producing an expandable polypropylene vacuum thermoforming product with an improved impact resistance.

In order to achieve the above objective, the present invention provides a molding method for expandable polypropylene, comprising the following steps:

1) Silk screen printing on a plastic sheet;

2) Subjecting the plastic sheet to vacuum thermoforming to provide a vacuum thermoforming part; and

3) Foaming an expandable polypropylene and integratedly molding the expandable polypropylene with the vacuum thermoforming part.

In said method of molding expandable polypropylene above, spray coating of a molded plastic sheet with ink may also be used instead of silk screen printing on a plastic sheet.

In the molding method of the present invention, an ink is used in step 1) for silk screen printing on a plastic sheet, wherein said ink is preferably an ink for expandable polypropylene.

In the molding method of the present invention, preferably, the thickness of said plastic sheet in step 1) ranges from 0.5˜2.5 mm.

In the molding method of the present invention, preferably, said expandable polypropylene used in step 3) is a modified expandable polypropylene.

In the molding method of the present invention, preferably, the operating pressure for the integrated molding in step 3) ranges from 280 kPa to 500 kPa.

In the molding method of the present invention, preferably, the operating temperature for the integrated molding in step 3) ranges from 125° C. to 150° C.

In the molding method of the present invention, preferably, the operating steam time for the integrated molding in step 3) ranges from 25 seconds to 60 seconds, wherein said steam time varies from products with different thickness.

According to the present invention, said expandable polypropylene and modified expandable polypropylene may be prepared by any methods known in the art, including injection foam molding, extrusion molding or compression molding. In one preferred embodiment, said expandable polypropylene and modified expandable polypropylene are prepared by injection foam molding. In another preferred embodiment, said expandable polypropylene and modified expandable polypropylene are prepared by extrusion molding or compression molding.

The advantages and beneficial effects of the one-step molding method according to the present invention lie in that the obtained expandable polypropylene vacuum thermoforming product exhibits an improved impact resistance, and the production process is more superior.

### BRIEF DESCRIPTION OF THE DRAWING

FIG. 1 is a flow chart showing the one-step molding method for expandable polypropylene plastic according to the present invention.

### DETAILED DESCRIPTION OF THE INVENTION

In order to further describe the principle and the structure of the present invention, detailed description of the preferred examples of the present invention will be made in reference to the accompanying drawing. However, said examples are only provided for illustration and explanation, which cannot be construed as a limitation of the protection scope of the present application.

### Example 1

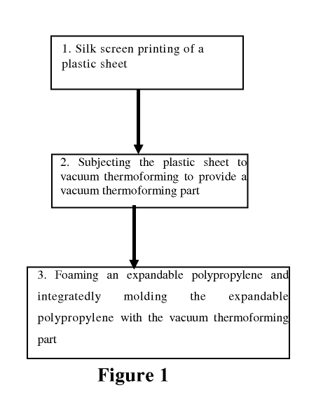

The molding method of the present invention will be exemplified with an expandable polypropylene (EPP) (from a Japanese company, JSP) below. As shown in FIG. 1, the molding method of the present invention comprises the following three steps: silk screen printing of a plastic sheet, vacuum thermoforming and processing of the plastic sheet, integrated molding of EPP with the vacuum thermoforming part.

Step 1: silk screen printing of a plastic sheet

1) Silk screen printing with two layers of colour paint. Each silk screen printed layer was subjected to baking at 80° C. for 20 minutes after printed with an ink (PU ink, from Miramar). Printing of the subsequent layer of ink was followed only after the first layer of ink was sufficiently dried.

2) Silk screen printing with two layers of EPP adhesive paint (material of said adhesive paint was a chlorinated polyolefin resin from Miramar). Each silk screen printed layer was subjected to baking at 80° C. for 20 minutes. Printing of the subsequent layer of ink was followed only after the first layer of ink was sufficiently dried. Said adhesive paint was an ink for expandable polypropylene.

Step 2: vacuum thermoforming and processing of the plastic sheet

1) Sheet baking. The plastic sheet was subjected to baking at about 95° C. for 90 minutes.

2) Adjusting the parameters of the vacuum thermoforming machine. Heating temperature was about 500° C., heating period was 18 seconds, and cooling period was 10 seconds.

3) Vacuum forming a thermoforming part with a specific shape by using a vacuum thermoforming mold.

4) Processing the vacuum thermoforming part, including punching and trimming so as to finish the specific shape.

Step 3: Foaming an expandable polypropylene and integratedly molding the expandable polypropylene with the vacuum thermoforming part

1) Adjusting the parameters of the foam-molding machine. The steam pressure was 300 kPa, the steaming period was 35 seconds, the cooling period was 120 seconds, the vacuum period was 20 seconds, and the temperature in the mold during molding was about 130° C.

2) Placing the processed thermoforming part into an EPP foaming mold.

3) Turning on the machine, feeding the EPP, and conducting EPP foaming according to the parameter setting. EPP foam was closely adhered to the vacuum thermoforming part, which resulted in the production of a product having the EPP foam integrated with the vacuum thermoforming part.

4) After demolding, the EPP foam and the vacuum thermoforming part were closely bonded together.

### Example 2

The molding method of the present invention will be exemplified with a modified expandable polypropylene (from a Japanese company, JSP) below. The molding method of the present invention comprises the following three steps: silk screen printing of a plastic sheet, vacuum thermoforming and processing of the plastic sheet, integrated molding of the EPP with the vacuum thermoforming part.

Step 1: silk screen printing of a plastic sheet

1) Silk screen printing with two layers of colour paint. Each silk screen printed layer was subjected to baking at 80° C. for 20 minutes after printed with an ink. Printing of the subsequent layer of ink was followed only after the first layer of ink was sufficiently dried.

2) Silk screen printing with two layers of EPP adhesive paint. Each silk screen printed layer was subjected to baking at 80° C. for 20 minutes. Printing of the subsequent layer of paint was followed only after the first layer of ink was sufficiently dried. The adhesive paint was an ink for expandable polypropylene.

Step 2: vacuum thermoforming and processing of the plastic sheet

1) Sheet baking. The plastic sheet was subjected to baking at about 95° C. for 90 minutes.

2) Adjusting the parameters of the vacuum thermoforming machine. The heating temperature was about 500° C., the heating period was 18 seconds and the cooling period was 10 seconds.

3) Vacuum forming a thermoforming part with a specific shape by using a vacuum thermoforming mold.

4) Processing the thermoforming part, including punching and trimming so as to finish the specific shape.

Step 3: Foaming an expandable polypropylene and integratedly molding the expandable polypropylene with the thermoforming part

1) Adjusting the parameters of the foam-molding machine. The steam pressure was 500 kPa, the steaming period was 35 seconds, the cooling period was 120 seconds, the vacuum period was 20 seconds, and the temperature in the mold during molding was about 150° C.

2) Placing the processed thermoforming part into an EPP foaming mold.

3) Turning on the machine, feeding the modified expandable polypropylene, and conducting foaming of the modified expandable polypropylene according to the parameter setting. Modified expandable polypropylene was closely adhered to the vacuum thermoforming part, which resulted in the production of a product having the modified expandable polypropylene integrated with the vacuum thermoforming part.

4) After demolding, the modified expandable polypropylene and the vacuum thermoforming part were closely bonded together.

In step 3 of Examples 1 and 2 above, the expandable polypropylene (EPP) and the modified expandable polypropylene were molded by injection foaming process. However, a skilled person in the art should be understood that the expandable polypropylene (EPP) and the modified expandable polypropylene can be molded by any other methods capable of producing the desired shape, such as extrusion molding, compression molding and the like.

Although the embodiments of the present invention have been described in details, it should be understood that various alterations or modifications may be made therein without departing from the spirit or scope of the invention, and that all modifications or alternatives equivalent thereto are within the spirit and scope of the invention as set forth in the appended claims.

1. A molding method for expandable polypropylene, comprising the acts of:
1) Silk screen printing on a plastic sheet;
2) Subject the plastic sheet to vacuum thermoforming to provide a vacuum thermoforming part;
3) Foaming an expandable polypropylene and integratedly molding the expandable polypropylene with the vacuum thermoforming part.

2. The molding method for expandable polypropylene according to claim 1, wherein an ink is used in act 1) for silk screen printing on a plastic sheet, and said ink is an ink for expandable polypropylene.

3. The molding method for expandable polypropylene according to claim 1, wherein the thickness of said plastic sheet in act 1) ranges from 0.5˜2.5 mm.

4. The molding method for expandable polypropylene according to claim 2, wherein the thickness of said plastic sheet in act 1) ranges from 0.5˜2.5 mm.

5. The molding method for expandable polypropylene according to claim 1, wherein said expandable polypropylene used in act 3) is a modified expandable polypropylene.

6. The molding method for expandable polypropylene according to claim 1, wherein the operating pressure for the integrated molding in act 3) ranges from 280 kPa to 500 kPa.

7. The molding method for expandable polypropylene according to claim 5, wherein the operating pressure for the integrated molding in act 3) ranges from 280 kPa to 500 kPa.

8. The molding method for expandable polypropylene according to claim 1, wherein the operating temperature for the integrated molding in act 3) ranges from 125° C. to 150° C.

9. The molding method for expandable polypropylene according to claim 5, wherein the operating temperature for the integrated molding in act 3) ranges from 125° C. to 150° C.

10. The molding method for expandable polypropylene according to claim 6, wherein the operating temperature for the integrated molding in act 3) ranges from 125° C. to 150° C.

11. The molding method for expandable polypropylene according to claim 1, wherein an operating steam time for the integrated molding in act 3) is 25 seconds to 60 seconds.

12. The molding method for expandable polypropylene according to claim 5, wherein an operating steam time for the integrated molding in act 3) is 25 seconds to 60 seconds.

13. The molding method for expandable polypropylene according to claim 6, wherein an operating steam time for the integrated molding in act 3) is 25 seconds to 60 seconds.

14. The molding method for expandable polypropylene according to claim 8, wherein an operating steam time for the integrated molding in act 3) is 25 seconds to 60 seconds.
